(19) United States
(12) Patent Application Publication
(10) Pub. No.: US 2016/0328785 A1
(43) Pub. Date: Nov. 10, 2016

(54) DEVICE AND METHOD FOR TARGETED DISPLAY OF INFORMATION

(71) Applicant: Alibaba Group Holding Limited, Grand Cayman (KY)

(72) Inventors: Ming Zhong, Hangzhou (CN); Suzhi Lin, Hangzhou (CN)

(21) Appl. No.: 15/146,015

(22) Filed: May 4, 2016

(30) Foreign Application Priority Data
May 7, 2015 (CN) 201510229607.1

(51) Int. Cl. G06Q 30/06

(52) U.S. Cl. CPC G06Q 30/0641; G06Q 30/0625

(57) ABSTRACT

The disclosure describes targeted display of information. A server receives a page request from a client for commodity data. A commodity main body image corresponding to the page request is acquired by the server, and the server identifies, according to the commodity main body image, from a tagged picture library, tagged sub-images corresponding to the commodity main body image. The server identifies user preference information according to user information included in the page request; and retrieves, according to the user preference information, from the tagged sub-images corresponding to the commodity main body image, one or more tagged sub-images corresponding to the user preference information. Thus, when facing overlapping and disorderly network information, a user can identify desired information without having to browse the network information piece by piece. Instead, the network information is displayed to the user according to the user's needs, thereby improving convenience in finding useful information.

### CROSS-REFERENCE TO RELATED APPLICATIONS

This application claims the benefit of priority of Chinese Application No. 201510229607.1, titled Method of Targeted Display of Information and Apparatus Thereof, filed on May 7, 2015, which is hereby incorporated by reference in its entirety.

### FIELD

The present disclosure relates to the field of computer technology, and, in particular, to a method and device for targeted display of information.

### BACKGROUND

With the continuous development of the internet, network service providers (such as, e.g., websites and network applications) can provide a variety of network services and display network information to users.

Network information provided by network service providers typically includes different types of information, such as text, sound, and video. However, the current techniques of displaying network information may cause the display of overlapping information and appear cluttered or disorganized. For example, if a large amount of overlapping and disorderly text information is mixed up with an image on a display, and the user wants to find useful information in such disorderly information, the typical way to do so is to browse the network information line by line to identify the information of interest.

For example, in some commodity websites, when a user uses keywords (such as product name) for searching, the search results are generally commodity images. However, the commodity images may contain text information which is overlapping and disorganized, and there may be a lot of information in the text information which is not of interest to the user. Thus, the user needs to browse all of the text information in order to identify what the user wants.

Overlapping and disorderly network information provided by a network service provider causes inconvenience to a user and makes it difficult to find useful information.

### SUMMARY

The present application provides a method and device for the targeted display of information to solve the problem of the difficulty in finding useful information on a display. In one aspect, a method for targeted display of information includes receiving, by a server computer from a client, a page request from a client for commodity data; acquiring, by the server computer, a commodity main body image corresponding to the page request; identifying, by the server computer in a tagged picture library, tagged sub-images corresponding to the commodity main body image; identifying, by the server computer, user preference information according to user information associated with the page request; retrieving, by the server computer from the tagged sub-images corresponding to the commodity main body image, one or more tagged sub-images corresponding to the user preference information; and transmitting, by the server computer, the one or more tagged sub-images and the commodity main body image to the user client, for rendering and display.

In one embodiment, the transmitting by the server includes transmitting the one or more tagged sub-images and commodity main body image to the client, for combination by the client and for display at the client. In one embodiment, the transmitting by the server includes transmitting the one or more tagged sub-images and the commodity main body image, for combination and display.

In one aspect, a method for the targeted display of information includes transmitting, by a client device to a server computer, a page request for commodity data; acquiring, by the client device, user preference information; receiving, by the client device, commodity image data returned from the server computer, wherein the commodity image data comprises a commodity main body image and at least one tagged sub-image; utilizing, by the client device, the user preference information to filter out the tagged sub-images which are irrelevant to the user preference information; and combining, by the client device, the remaining tagged sub-images, after the filtering out process, with the commodity main body image, for rendering and displaying.

In one aspect, a device for the targeted display of information includes receiver logic executed by a processor for receiving a page request from a client for commodity data; acquisition logic executed by the processor for acquiring a commodity main body image corresponding to the page request; first identification logic executed by the processor for identifying, in a tagged picture library, tagged sub-images corresponding to the commodity main body image; second identification logic executed by the processor for identifying user preference information according to user information carried by the page request; third identification logic executed by the processor for retrieving, according to the user preference information, from the tagged sub-images corresponding to the commodity main body image, one or more tagged sub-images corresponding to the user preference information; and transmitting logic executed by the processor for transmitting the one or more tagged sub-images and the commodity main body image to the client, for rendering and display.

In one embodiment, a client utilizes the user preference information to filter out tagged sub-images which are irrelevant to the user preference information.

In one embodiment, when the client sends a page request for commodity data to the server computer, the server computer determines the commodity main body image according to the page request, and identifies the preference information of the user according to the user information carried by the page request. The server computer then further identifies tagged sub-images of the corresponding commodity according to the preference information, and sends the identified tagged sub-images and the commodity main body image together to the client for rendering and display to the user. This method of displaying commodity images simplifies information displayed with the commodity images, avoids overlapping and disorderly information displayed with the commodity images, and effectively improves user experience in finding commodity information.

### BRIEF DESCRIPTION OF THE DRAWINGS

Drawings illustrated herein are used for facilitating a better understanding of the disclosure, and constitute an integral part of the disclosure. The illustrated embodiments of the disclosure and descriptions thereof are used for explaining the disclosure, and would not constitute inappropriate limitations on the disclosure. In the drawings:

FIG. 1 is a schematic process diagram of a method for displaying information provided in an embodiment of the application;

FIG. 2 is a schematic diagram of the commodity main body image of commodity A provided in an embodiment of the application;

FIG. 3 is a schematic diagram of the tagged sub-images corresponding to commodity A provided in an embodiment of the application;

FIG. 4 is a schematic diagram of the tagged sub-images of the first displayed commodity A provided in an embodiment of the application;

FIG. 5 is a schematic diagram of the tagged sub-images of the second displayed commodity A provided in an embodiment of the application;

FIG. 6 is a schematic process diagram of another method for displaying information provided in an embodiment of the application;

FIG. 7 is a schematic process diagram of a further method for displaying information provided in an embodiment of the application;

FIG. 8a is a schematic diagram of commodity images uploaded in Scalable Vector Graphics (SVG) format provided in an embodiment of the application;

FIG. 8b is a schematic diagram of storing, by the server, the commodity images in SVG format in different layers;

FIG. 9 is a structural schematic diagram of a device for displaying information provided in an embodiment of the application; and

FIG. 10 is a structural schematic diagram of another device for displaying information provided in an embodiment of the application.

### DETAILED DESCRIPTION

The present disclosure will now be described more fully hereinafter with reference to the accompanying drawings, which form a part hereof, and which show, by way of illustration, certain example embodiments. Subject matter may, however, be embodied in a variety of different forms and, therefore, covered subject matter is intended to be construed as not being limited to any example embodiments set forth herein; example embodiments are provided merely to be illustrative. Likewise, a reasonably broad scope for covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the disclosure, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

A computing device may operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems.

A client device may vary in terms of capabilities or features. Disclosed subject matter is intended to cover a wide range of potential variations. For example, a simple smart phone, phablet or tablet may include a numeric keypad or a display. In contrast, however, as another example, a web-enabled client device may include a high resolution screen, one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

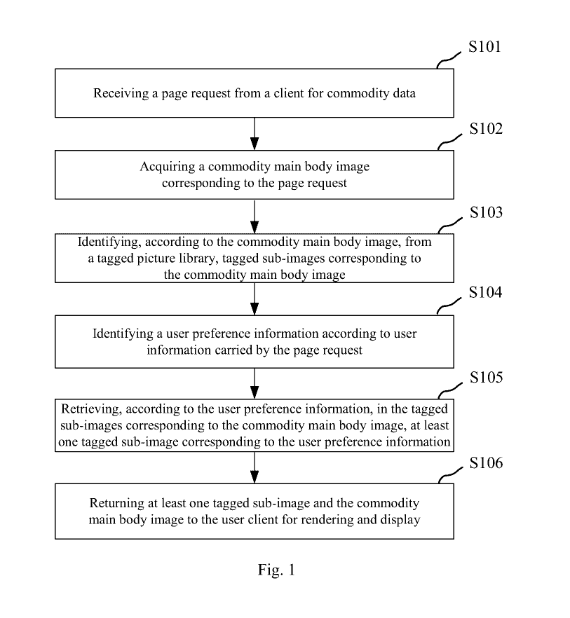

FIG. 1 depicts a flowchart of a process for targeted display of information provided in an embodiment of the application, which comprises the following step:

S101: receiving a page request from a client for commodity data.

In this step, the page request comprises, but is not limited to: a browse request and/or a search request for the commodity data in the page. The client includes, but is not limited to, a terminal such as a smart phone, a tablet, a computer, a smart television, or the like.

The commodity data is stored on a server (or in a database) of a corresponding commodity website; thus, a user can use an application or a browser in the client to access the corresponding commodity website to view the commodity data (e.g., to send a page request for commodity data).

In embodiments of the process, the commodity data comprises commodity main body images, commodity features, detailed commodity information, etc. for various commodities.

The next step in the process is, in one embodiment:

S102: acquiring a commodity main body image corresponding to the page request.

In this step, the commodity main body image comprises, but is not limited to, one or more images, rendered image and/or dynamic image used to characterize the commodity profile.

When a user wants to browse or search for a certain commodity, the user will send a corresponding page request through the client. Thus, the page request can include corresponding commodity information. After receiving the page request, the server identifies a commodity main body image for the target commodity according to the transmitted commodity information.

The next step in the process is, in one embodiment:

S103: identifying, in a tagged image library, tagged sub-images corresponding to the commodity main body image according to the commodity main body image.

With respect to user preference information, this can vary depending on different commodities. For example, a user A may focus on the commodity feature of “free shipping” with respect to clothing, while user A may focus on the commodity feature of “authentic product” with respect to electronic products. It is evident that preferences of the same user for different commodities are often different.

Therefore, with respect to different commodities, in order to ensure accurate display of the commodity features (tagged sub-images) that the user desires, the server needs to identify tagged sub-images corresponding to the commodity intended for the user to browse.

The next step in the process is, in one embodiment:

S104: identifying user preference information according to user information carried by the page request.

In one embodiment, with respect to the user information, if the user has registered on a corresponding commodity website and logged into the commodity website, the user information comprises, but is not limited to: user identity (ID) or user account information. In one embodiment, if the user has not yet registered, the user information comprises, but is not limited to: media access control (MAC) address of the client, internet protocol (IP) address where the client accesses the network, etc.

Different commodities generally have different features, such as types, service conditions, status, and valid period of commodities. A user is often focused on a particular commodity feature when browsing commodities. Thus, in this embodiment, the user preference information is the information regarding the particular commodity feature that the user is focused on with respect to different commodities.

The user may have browsed or searched for the commodity data at one or more points in time, and the server may have recorded historical network behaviors of the user with respect to the commodity data. For example, the server can store not only browsing and searching information, but the server can also store the user subscribing, ordering and other operations with respect to the commodity. The server can identify the preferred commodity features of the user for different commodities according to recorded historical network behaviors as the preference information of the user.

For example, user A often focuses on clothing with the commodity feature of “100% pure cotton”. In this example, the commodity feature of “100% pure cotton” that user A is focused on with respect to commodities of clothing is the preference information of user A.

User preference information collected by the server can be stored in a corresponding user preference database. Thus, once the server identifies the user information, it can further identify the preference information of this user.

The next step in the process is, in one embodiment:

S105, retrieving, according to the user preference information, from tagged sub-images corresponding to the commodity main body image, one or more tagged sub-images corresponding to the user preference information.

The tagged sub-image comprises a vector graph and/or a bitmap used to characterize the commodity feature, e.g., the tagged sub-image in the embodiments of the disclosure is a commodity feature displayed in the form of an image.

In one embodiment, the tagged sub-images can be created by the user and then uploaded, and the tagged sub-image can also be generated by the server by combining commodity features (in the form of text) of different commodities according to a pre-stored image template.

After the server identifies the preference information of the user, the server can identify the tagged sub-image of the commodity feature intended for the user to browse according to the preference information.

The next step in the process is, in one embodiment:

S106, returning or transmitting one or more tagged sub-image and the commodity main body image to the user client, for rendering and display.

In the prior art, there is often a large amount of disorderly tag information on a commodity image, which decreases the efficiency of the user in finding the commodity information.

Unlike the prior art, in the present disclosure, through steps S101-S104 described above, the server identifies, according to preference information of the user, the corresponding tagged sub-images and the commodity main body image that the user can browse. The server sends the tagged sub-images and the commodity main body image described above together to the client, and the client combines and displays these tagged sub-images and the commodity main body image (in one embodiment, the tagged sub-images are attached to the commodity main body image). Thus, the commodity image that the user sees on a display of the client contains the tagged sub-images corresponding to the preferred commodity feature of the user, and does not see a large amount of disorderly information on the commodity image.

Through the steps described above, in one embodiment, when a user sends a page request for commodity data via the client, the server identifies a commodity main body image according to this page request, and identifies the preference information of the user according to user information carried by the page request, and then identifies the tagged sub-images of the corresponding commodity according to the preference information. In one embodiment, the server combines the tagged sub-images and the commodity main body image together and sends the combined identified tagged sub-images and the commodity main body image to the client for rendering and display to the user. This method of displaying a commodity image simplifies information displayed in the commodity image, avoids overlapping and disorderly information displayed on the commodity image, and effectively improves the user experience in finding commodity information.

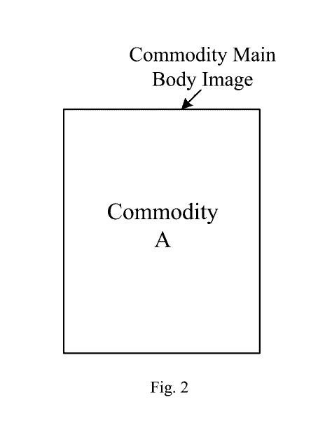

FIG. 2 shows an embodiment of the method above described as applied to a particular application example. For example, as shown in FIG. 2, it is assumed that commodity A on a commodity website has two commodity features: “on sale” and “new”.

It is assumed that the user preference information of user A is focusing on the commodity feature “on sale” of commodity A. User A then logs into the commodity website via mobile phone, and sends a search request with respect to commodity A on the commodity website.

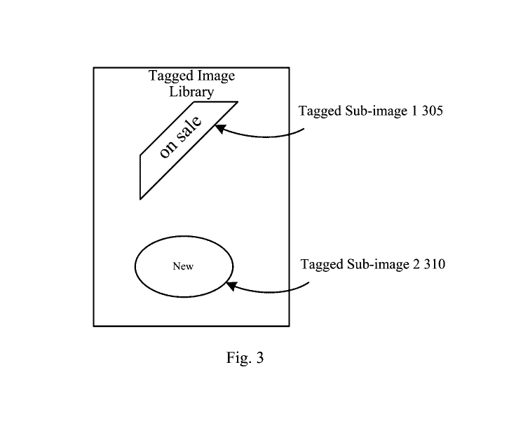

After receiving the search request sent by the mobile phone with respect to commodity A, the server identifies, according to this search request, a commodity main body image 200 (as shown in FIG. 2) of commodity A that the user is looking for and (e.g., all) commodity features (e.g., the two commodity features: “on sale” and “new”) of commodity A. Then, according to the commodity features of the commodity A, the server retrieves various tagged sub-images corresponding to various commodity features from a tagged picture library. In other words, in one embodiment and as shown in FIG. 3, the server has identified two tagged sub-images corresponding to commodity A in the tagged picture library, e.g., tagged sub-image 1 305 with the word “on sale” and tagged sub-image 2 310 with the word “new”.

The server can also identify the preference information of user A according to the account information of user A included in the search request, e.g., the server learns that user A is focused on the commodity feature “on sale” with respect to commodity A.

Then, the server, according to the preference information of user A, locates the tagged sub-image matched with the user preference information of user A in (e.g., all) tagged sub-images corresponding to commodity A. Thus, the server identifies the tagged sub-image with the word “on sale” (tagged sub-image 1 305) according to the preference information of user A.

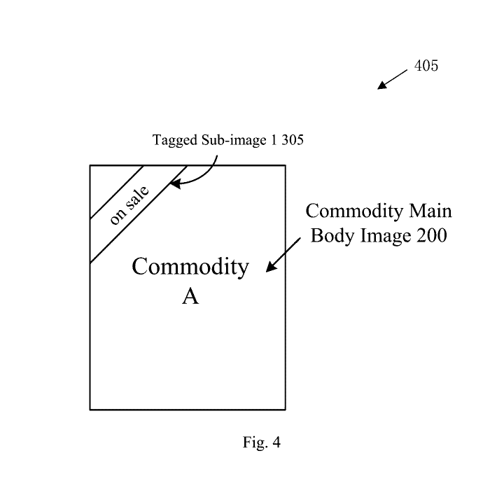

Then, the server sends the commodity main body image and the tagged sub-image 1 of the commodity A together to the mobile phone used by user A, and as shown in FIG. 4, the commodity main body image 200 and the tagged sub-image 1 305 are combined into one commodity image 405 for rendering on a display.

In one embodiment, the user preference information of user B is focused on the commodity feature “new” in commodity A. User B logs into the commodity website via a mobile phone, and sends a browse request with respect to commodity A on the commodity website.

As described above, the server, according to the browse request sent by user B, identifies the commodity main body image of commodity A and (e.g., all) commodity features of commodity A, and then identifies two tagged sub-images corresponding to commodity A.

In one embodiment, the server identifies the preference information of user B according to the account information of user B included in the browse request, e.g., the server learns that user B is focused on the commodity feature “new” with respect to commodity A. The server identifies the tagged sub-image with the word “new” (tagged sub-image 2 310) according to the preference information of user B.

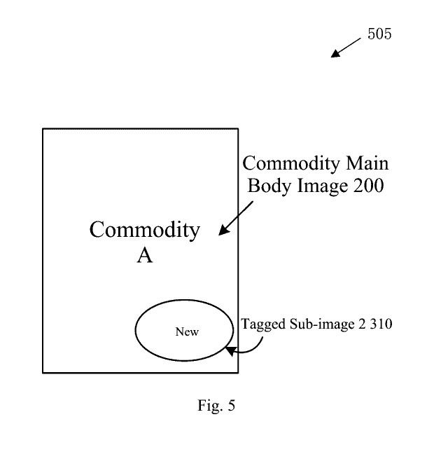

Then, the server sends the commodity main body image and the tagged sub-image 2 of the commodity A together to the mobile phone used by user B, and as shown in FIG. 5, the commodity main body image 200 and the tagged sub-image 2 310 are combined into one commodity image 505 for rendering on a display.

In embodiments described above, with respect to individual preferences of different users, the tagged sub-image to be displayed will be different; when the client used by the user sends a page request, the server identifies a commodity main body image intended for the user to browse, and, according to the preference of the user, locates the tagged sub-image that matches with the preference of the user, and combines the tagged sub-image and the commodity main body image to display to the user.

Thus, the server transmits to the client the corresponding tagged sub-image for display to the user according to the preference of the user (user preference information), while the user preference information of the user is often reflected by historical or current network operations of the user. Thus, the server can identify the user preference information of the user (that is the commodity feature that the user is focused on) according to network operations of the user, and the process and method of identifying the user preference information of a user in an embodiment of the application is described in more detail below.

In embodiments, a user can directly browse various commodity information displayed on a corresponding recommended page (such as a home page of a commodity website) in a corresponding commodity website, and can also browse the commodity information on the page of search results retrieved by inputting respective keywords. Thus, when the page request comprises the browse request for commodity data on the page, identifying user preference information according to user information carried by the page request is , in one embodiment, as follows: acquiring pre-recorded historical browsing features of the user for the commodity data according to the user information included in the browse request, and using the historical browsing features as the preference information of the user.

In one embodiment, the user may browse data of many different commodities, and when the user browses data of different kinds of commodities, the user may be focused on different commodity features with respect to different kinds of commodities. For example, for electronic commodities, a user may be focused more on the commodity feature “authentic product”, but for daily supplies, a user may be more focused on the commodity feature “free shipping”. Then, in order to accurately identify the user preference information of a user, the server identifies the commodity data corresponding to the browsing operation currently performed by the user.

In one embodiment, considering that the user may have already performed operations with respect to the data of corresponding commodities, and the server has recorded the historical data associated with this user, after the server identifies the commodity data corresponding to the browsing operation currently performed by the user, the server uses the pre-recorded historical data associated with the user with respect to this commodity data as the user preference information of this user.

In one embodiment, pre-recording historical data associated with the user can be as follows: pre-recording different commodity data respectively corresponding to historical data associated with (e.g., historical browsing or searching operations of) the user, identifying, respectively, commodity features contained in different commodity data, and using the commodity features so identified as the historical data associated with the user.

For example, at one or more points in time, the user performed multiple browsing operations for commodity data B. The browsing operations of the user for commodity B at the one or more points in time are historical browsing operations, and if it is assumed that the commodity feature contained in the commodity B is “authentic product”, then the server records “authentic product” as the historical data associated with this user with respect to the commodity B.

Therefore, when the user is browsing the searched results page comprising commodity B, the server identifies the commodity data (e.g., commodity B) corresponding to the one or more current browsing operations of this user, and presents, according to the historical data associated with the user, commodity B with an “authentic product” feature tag on the searched results page.

In one embodiment, multiple scenarios in the identification of the historical data associated with the user exist, such as:

In the case that the user possesses an account (which indicates that this user has registered on the server), the server can record historical operations of this user according to the account information with which the user logs into the website, and identify, according to the recorded historical operations, historical operation features (e.g., historical browsing or searching data) corresponding to the historical operations. In one embodiment, when the user has not registered, according to the Internet protocol (IP) address of the client used by the user, the server may record historical operations corresponding to the IP address, and then identify the historical operation information corresponding to the historical operations.

It should be noted that the historical operations mentioned above are not limited to the above browsing operations and searching operations with respect to the commodity data, but also include, by way of non-limiting examples, order-placing operations, bookmarking operations, subscription operations, and the like.

It should also be noted that in some embodiments, the user may have multiple historical operation features or data, and the commodity data corresponding to the current browsing operation of the user also has multiple commodity feature tags. In such embodiments, in order to avoid too many tagged image templates being displayed on the commodity image, in one embodiment a threshold value of the number of commodity feature tags to be displayed will be specified. For example, the threshold value of the number to be displayed is specified to, e.g., 2, which means that on one commodity image, only up to two tagged image templates will be displayed, thereby ensuring that there is no overlapping and/or disorderly commodity data displayed on the page.

Alternatively, if the multiple historical operation features of the user are identical with the multiple commodity feature tags carried by the currently browsed commodity data, it selects, from multiple identical features, two feature tags, and accordingly the tag feature templates corresponding thereto for display on the image of the commodity data. In one embodiment, the server may select the two most popular commodity feature tags in accordance with a statistic result of popularity of a certain amount of commodity data, and display the tag picture templates corresponding to the two commodity feature tags on the image of the commodity data.

On the basis of identifying browsing operation information of the user described above, identifying the feature tag that matches with the specified operation information is, in one embodiment, as follows: identifying, according to the browsing operation of the user, from the commodity feature tags corresponding to various stored commodity data, the commodity feature tags which are of the same types as the historical operation features.

As the browsing operation of a user is the historical operation feature of the user, the server can, according to the historical operation features of the user, match the browsing operations with the commodity feature tags corresponding to various stored commodity data.

In one embodiment, considering that the historical operation features or data associated with the user may not be entirely consistent with the commodity feature tags corresponding to the commodity data, for example, assuming that the user has browsed commodity C with “on sale” tag multiple times at different points in time, the historical operation feature of the user with respect to the commodity C can be considered as “on sale”. However, in one embodiment the commodity feature tag corresponding to commodity C currently stored on the server is “promotion”. Although the two feature tags are not identical, the two feature tags have similar meanings or are features of a similar type. Therefore, the server identifies the commodity feature tag that is of the same type as the historical operation feature as the feature tag that matches with the browsing operation information of the user.

In addition to the browsing operation described above, in one embodiment, the user may directly search for a commodity feature tag. For example, the user may input the keyword “new” on a commodity website, which is a commodity feature tag. In this embodiment, when the specified operation comprises searching operation with respect to the commodity feature tag, identifying the specified operation information corresponding to the specified operation is, in one embodiment, identifying the keyword for the searching operation, and using the keyword as the searching operation information corresponding to the searching operation.

Identifying the feature tag that matches the specified operation information is, in one embodiment, identifying from the feature tags corresponding to various stored commodity data the commodity feature tag that is of the same type as the keyword.

Thus, the server can use the keyword input by the user as part of the searching operation information, and match the keyword with the feature tags corresponding to various stored commodity data to identify the feature tag corresponding to the keyword. In this way, the server can identify a variety of commodity data, and these identified commodity data includes the same feature tag.

Continuing with the example above, after the user inputs the keyword “new”, different kinds of commodities (such as clothing, electronic products and household appliances) are displayed on the search results page, and these different kinds of commodities include the “new” tag.

Thus, in one embodiment, the screening process of tagged sub-images is accomplished by the server, while, in one embodiment, the server downloads image data of the commodity to the client such that the screening and filtering operations of tagged sub-images are performed by the client.

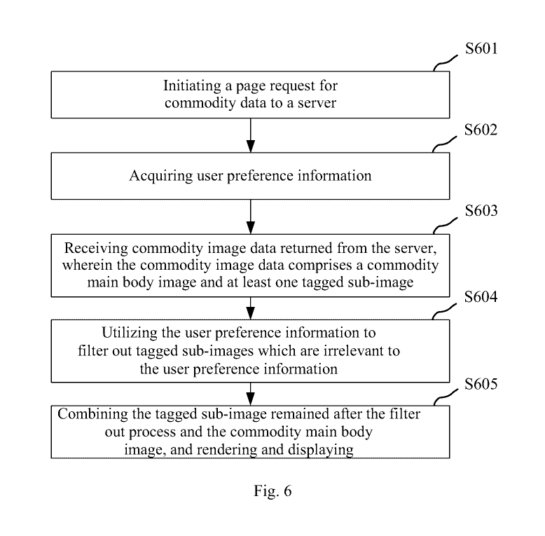

Therefore, in one embodiment, as shown in FIG. 6, another method for displaying targeted information is provided, and the method comprises, in one embodiment, the following steps:

S601, initiating a page request to a server for commodity data;

S602, acquiring user preference information;

S603, receiving commodity image data returned from the server, wherein the commodity image data comprises a commodity main body image and one or more tagged sub-images;

S604, utilizing the user preference information to filter out tagged sub-images that are irrelevant to the user preference information; and

S605, combining the remaining tagged sub-image after the filter out process with the commodity main body image, for rendering and displaying.

In one embodiment, the page request comprises a browse request and/or a search request on the page. The commodity main body image comprises at least one image, rendered image and dynamic image used to characterize a commodity profile. The tagged sub-image comprises a vector graph and/or bitmap used to characterize commodity features.

Through the steps described above, after a user sends a page request to a server via a client, the client will receive the commodity image data returned from the server, and according to the acquired user preference information, the client filters out the tagged sub-images which are irrelevant to the user preference information from the commodity image data. As such, the commodity image intended for the user to browse comprises the tagged sub-images of the commodity features that the user wants. This not only avoids overlapping and disorderly information on the commodity image, but also improves user's efficiency in finding the commodity information.

It should be noted that for step S602 described above, multiple methodologies can be used.

One embodiment is that the user preference information is stored on the server. In this embodiment, the client needs to acquire the user preference information from the server. Thus, when the user preference information is stored on the server, acquiring user preference information is, in one embodiment, as follows: sending a query request to the server by the client, such that the server identifies, according to the query request, the user preference information corresponding to the user information (wherein the user information is included in the query request), and receiving the user preference information returned from the server.

In another embodiment, the user preference information is stored locally on the client, and then the client can acquire the user preference information directly. Thus, when the user preference information is stored on the client, acquiring user preference information is, in one embodiment, identifying, according to the user information, the user preference information corresponding to the user information from user preference information locally stored on the client.

After acquiring the preference information of the user, the server can identify the tagged sub-image corresponding to the commodity feature that the user wants according to the user preference information. Since the user can be focused on different commodity features with respect to different commodities, the client needs to identify the commodity main body image of a commodity from the commodity image data sent by the server, and then identify, according to the user preference information, the tagged sub-image conforming with the user preference information from (e.g., some or all) tagged sub-images corresponding to this commodity main body image. In one embodiment, the client utilizing the user preference information to filter out tagged sub-images that are irrelevant to the user preference information includes, in one embodiment, acquiring the commodity main body image corresponding to the page request from the commodity image data, and according to the user preference information, filtering out tagged sub-images that are irrelevant to the user preference information from (e.g., all) tagged sub-images corresponding to the commodity main body image.

It should be noted that, with respect to the above content, the process for filtering out irrelevant tagged sub-images according to the user preference information and the process of acquiring the user preference information are similar to that discussed in S101-S105 of the method shown in FIG. 1, and thus will not be repeated here.

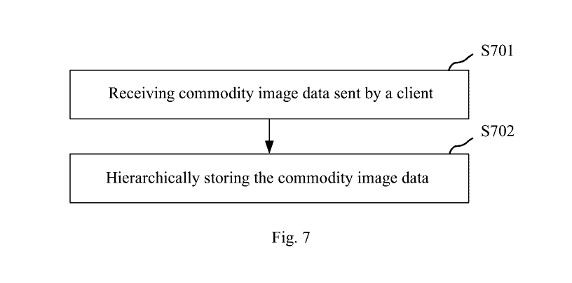

In one embodiment, a process for targeted display of information is provided. As shown in FIG. 7, the process comprises, in one embodiment, the following step:

S701: receiving commodity image data sent by a user, wherein the commodity image data comprises a commodity main body image and one or more tagged sub-image.

In one embodiment, the server receives the commodity image data uploaded by the client, and in one embodiment, the commodity image data may be completed by the client.

For example, the client converts the commodity main body image and text information in image format to a file in Scalable Vector Graphics (SVG) format, and sends it to the server as the commodity image data.

The next step in the process is, in one embodiment:

S702: hierarchically storing the commodity image data.

As used herein, “hierarchically storing” means storing the commodity main body image and the tagged sub-images carried by the commodity image data on the server separately.

In one embodiment, the commodity image data uploaded by the user is a complete commodity image (the commodity main body image and (e.g., some or all) tagged sub-images corresponding to this commodity main body image are combined into one commodity image), e.g., a SVG image. In one embodiment, after receiving the SVG image, the server can employ a corresponding image segmentation technique to extract the commodity main body image and (e.g., some or all) tagged sub-images in the SVG picture separately for hierarchically storing.

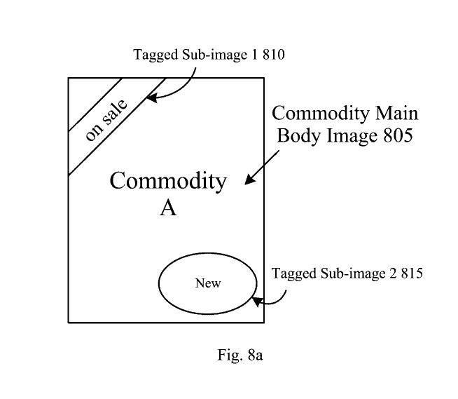

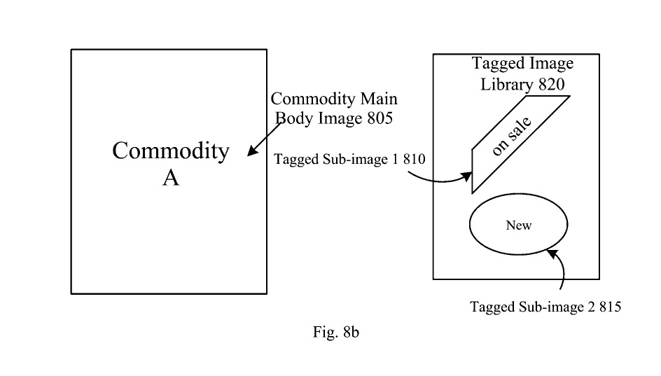

For example, as shown in FIG. 8a, assuming that the server receives an SVG image of commodity A sent by the user, in FIG. 8a, commodity main body image 805 of the commodity A comprises two tagged sub-images: tagged sub-image 1 810 with the word “on sale” and tagged sub-image 2 815 with the word “new”.

The server can hierarchically store the SVG image, e.g., as shown in FIG. 8b, and the server extracts the commodity main body image 805 and two tagged sub-images 810, 815 of commodity A in the SVG image separately, and stores the tagged sub-images 810, 815 in a tagged image library 820.

For steps S701-S702 of the method as shown in FIG. 7, the tagged sub-images in the tagged image library may also be generated and pre-stored by the server (in one embodiment, not created and then uploaded by the user).

Based on the same idea as the method for targeted display of information provided above in embodiments of the disclosure, an embodiment of the present disclosure also provides a device for displaying information.

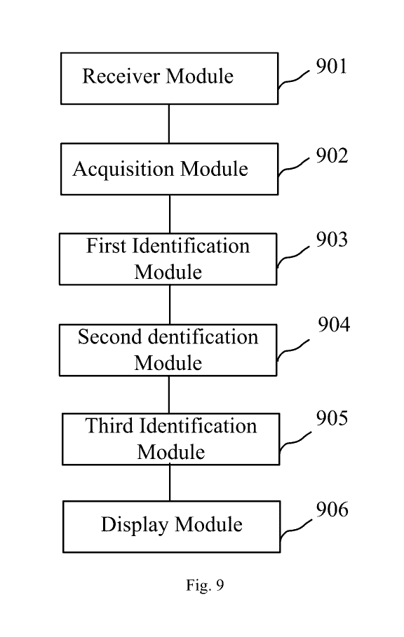

As shown in FIG. 9, a device for targeted display of information provided by one embodiment is provided on the server, and the device comprises, in one embodiment: a receiver module 901 for receiving a page request from a client for commodity data; an acquisition module 902 for acquiring a commodity main body image corresponding to the page request; a first identification module 903 for identifying, according to the commodity main body image, from a tagged image library tagged sub-images corresponding to the commodity main body image; a second identification module 904 for identifying user preference information according to user information carried by the page request; a third identification module 905 for retrieving, according to the user preference information, from the tagged sub-images corresponding to the commodity main body image one or more tagged sub-image corresponding to the user preference information; and a display module 906 for returning one or more tagged sub-image and the commodity main body image to the user client, for rendering and display.

In one embodiment, the first identification module 903 is also used for identifying (e.g., some or all) tagged sub-images corresponding to the commodity main body image.

In the embodiment of the application, the page request comprises a browse request and/or a search request for the commodity data on the page. The commodity main body image comprises at least one image, rendered image and dynamic image used to characterize a commodity profile. The tagged sub-image may include a vector graph and/or a bitmap used to characterize commodity features.

When the page request comprises a browse request for the commodity data on the page, the second identification module 904 is used for acquiring, according to the user information carried by the browse request, pre-recorded historical browsing features of the user for the commodity data, and using the historical browsing features as preference information of the user.

The second identification module 904 is used for pre-recording different commodity data separately corresponding to historical operations of the user, identifying separately commodity features contained in different commodity data, and using the identified commodity features as historical operation features of the user.

When the page request comprises a search request for the commodity data on the page, the second identification module 904 is used for, in one embodiment, identifying a search term corresponding to the search request; wherein the search term indicates the commodity feature; identifying, in various stored commodity data, the commodity feature that is of the same type as the search term; and using the identified commodity feature as the user preference information.

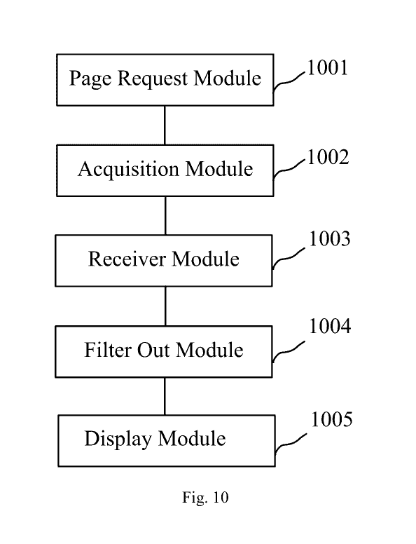

As shown in FIG. 10, a device for targeted display of information provided by one embodiment is provided on the client, and the device comprises, in one embodiment: a page request module 1001 for initiating a page request for commodity data to a server; an acquisition module 1002 for acquiring user preference information; a receiver module 1003 for receiving commodity image data returned from the server, wherein the commodity image data comprises a commodity main body image and at least one tagged sub-image; a filter-out module 1004 for utilizing the user preference information to filter out tagged sub-images which are irrelevant to the user preference information; and a display module 1005 for combining the remaining tagged sub-image after the filter out process with the commodity main body image, for rendering and displaying the combined image.

In one embodiment, when the user preference information is stored on the server, the acquisition module 1002, in one embodiment, sends a query request to the server, such that the server locates, according to the query request, the user preference information corresponding to the user information (wherein the user information is included in the query request), and receives the user preference information returned from the server.

While the user preference information is stored on the client, the acquisition module 1002, in one embodiment identifies, according to the user information, from the user preference information locally stored on the client, the user preference information corresponding to the user information.

The filter out module 1004, in one embodiment, acquires, from the commodity image data, the commodity main body image corresponding to the page request, and filters out, according to the user preference information, from (e.g., all) tagged sub-images corresponding to the commodity main body image, the tagged sub-images which are irrelevant to the user preference information.

In one embodiment, the page request comprises a browse request and/or a search request on the page. The commodity main body image comprises at least one image, rendered image and dynamic image used to characterize the commodity profile. The tagged sub-image can include a vector image and/or a bitmap used to characterize commodity features.

In a typical configuration, a computing device comprises one or more processors (CPU), input/output interfaces, network interfaces and memories.

The memory may include a volatile memory, a random access memory (RAM) and/or a non-volatile memory in computer readable medium, such as read-only memory (ROM) or flash memory (flash RAM). Memory is an example of computer readable media.

The computer readable medium comprises non-volatile and volatile, mobile and non-mobile media and can achieve information storage by any method or technique. The information can be computer readable instructions, data structures, program modules or other data. Examples of computer storage medium include, but are not limited to, a phase-change memory (PRAM), static random access memory (SRAM), dynamic random access memory (DRAM), other types of random access memory (RAM), read-only memory (ROM), electrically erasable, programmable read-only memory (EEPROM), flash memory or other memory techniques, compact disk read-only memory (CD-ROM), digital versatile disk (DVD) or other optical storage, cassette magnetic tape, magnetic tape disk memories or other magnetic storage devices or any other non-transmission medium which can be used to store information which can be accessed by the computing device. According to definition herein, the computer readable medium excludes transitory media, such as modulated data signal and carrier wave.

It should also be noted that the terms “include”, “comprise” or any other variant thereof are meant to encompass non-exclusive inclusion, such that the process, method, commodity or device including a series of elements not only comprises these elements, but also comprises other elements which are not set forth specifically, or also comprises the elements inherent in this process, method, commodity or device. In the absence of more limitations, the element defined by the sentence “including a . . . ” does not exclude other same elements which are also present in the process, method, commodity or device including the element.

It should be understood by those skilled in the art that embodiments of the application may be provided as a method, a system or a computer program product. Therefore, the application can employ a full hardware embodiment, a full software embodiment or an embodiment which is a combination of software and hardware. Moreover, the application may employ the form of a computer program product which can be implemented on one or more computer available storage media (including but not limited to magnetic disk memory, CD-ROM, optical memory, etc.) which comprises computer available program codes therein.

The foregoing are only embodiments of the application, and are not used to limit the application. To those skilled in the art, the application may have various modifications and changes and any modifications, equivalent replacements, improvements and the like made within the spirit and principle of the application would be within the scope of the Claims of the present application.

1. A method for displaying information, comprising:
receiving, by a server computer from a client, a page request for commodity data;
acquiring, by the server computer, a commodity main body image corresponding to the page request;
identifying, by the server computer, according to the commodity main body image, from a tagged image library, tagged sub-images corresponding to the commodity main body image;
identifying, by the server computer, user preference information according to user information carried by the page request;
retrieving, by the server computer, according to the user preference information, from the tagged sub-images corresponding to the commodity main body image, one or more tagged sub-images corresponding to the user preference information; and
transmitting, by the server computer, the one or more tagged sub-images and the commodity main body image to the client, for rendering and display.

2. The method according to claim 1, wherein the page request comprises one or more of a browse request and a search request for the commodity data on the page;
the commodity main body image comprises one or more image, rendered image and dynamic image used to characterize a commodity profile; and
the one or more tagged sub-images comprise one or more of a vector image and a bitmap used to characterize a commodity feature.

3. The method according to claim 2, wherein when the page request comprises a browse request for the commodity data on the page, identifying user preference information according to user information carried by the page request comprises:
acquiring, according to the user information carried by the browse request, pre-recorded historical browsing features of the user for the commodity data, and using the historical browsing features as the user preference information.

4. The method according to claim 3, wherein pre-recording the historical browsing features of the user for the commodity data specifically comprises:
pre-recording separately different commodity data corresponding to historical operations of the user;
identifying separately commodity features contained in different commodity data; and
using the identified commodity features as historical operation features of the user.

5. The method according to claim 3, wherein when the page request comprises a search request for the commodity data on the page, identifying user preference information according to user information carried by the page request comprises:
identifying a search term corresponding to the search request, wherein the search term indicates the commodity feature;
identifying from various stored commodity data the commodity feature that is of a same type as the search term; and
using the identified commodity feature as the user preference information.

6. The method according to claim 1, wherein the transmitting, by the server computer, of the one or more tagged sub-images and commodity main body image to the client further comprises transmitting the one or more tagged sub-images and commodity main body image to the client, for combination by the client and for display at the client.

7. The method according to claim 1, wherein the transmitting, by the server computer, of the one or more tagged sub-images and commodity main body image to the client further comprises transmitting the one or more tagged sub-images and commodity main body image, for combination and display.

8. A method for displaying information, comprising:
transmitting, by a client device to a server computer, a page request for commodity data;
acquiring, by the client device, user preference information;
receiving, by the client device, a commodity image data returned from the server, wherein the commodity image data comprises a commodity main body image and at least one tagged sub-image;
utilizing, by the client device, the user preference information to filter out tagged sub-images which are irrelevant to the user preference information; and
combining, by the client device, remaining tagged sub-images, after the filtering out process, with the commodity main body image, for rendering and displaying.

9. The method according to claim 8, wherein when the user preference information is stored on the server computer, the acquiring, by the client device, of the user preference information comprises:
sending, by the client device to the server computer, a query request, to facilitate the server computer identifying, according to the query request, the user preference information corresponding to the user information, wherein the user information is carried by the query request; and
receiving, by the client device, the user preference information returned from the server computer; and
when the user preference information is stored in the client device, the acquiring of the user preference information comprises:
identifying, by the client device according to the user information, from the user preference information locally stored in the client device the user preference information corresponding to the user information.

10. The method according to claim 8, wherein the utilizing of the user preference information to filter out tagged sub-images which are irrelevant to the user preference information further comprises:
acquiring, by the client device from the commodity image data, the commodity main body image corresponding to the page request; and
filtering out, by the client device according to the user preference information, from the tagged sub-images corresponding to the commodity main body image the tagged sub-images which are irrelevant to the user preference information.

11. The method according to claim 8, wherein the page request comprises one or more of a browse request and a search request on the page;
the commodity main body image comprises at least one image, rendered image and dynamic image used to characterize the commodity profile; and
the remaining tagged sub-images comprise one or more of a vector image and a bitmap used to characterize a commodity feature.

12. A device for displaying information, comprising:
a processor;
a storage medium for tangibly storing thereon program logic for execution by the processor, the program logic comprising:
receiver logic executed by the processor for receiving a page request from a client for commodity data;
acquisition logic executed by the processor for acquiring a commodity main body image corresponding to the page request;
first identification logic executed by the processor for identifying, according to the commodity main body image, from a tagged picture library, tagged sub-images corresponding to the commodity main body image;
second identification logic executed by the processor for identifying user preference information according to user information carried by the page request;
third identification logic executed by the processor for retrieving, according to the user preference information, from the tagged sub-images corresponding to the commodity main body image, one or more tagged sub-images corresponding to the user preference information; and
transmitting logic executed by the processor for transmitting the one or more tagged sub-images and the commodity main body image to the client, for rendering and display.

13. The device according to claim 12, wherein the page request comprises one or more of a browse request and a search request for the commodity data on the page;
the commodity main body image comprises at least one image, rendered image and dynamic image used to characterize a commodity profile; and
the one or more tagged sub-images comprising one or more of a vector image and a bitmap used to characterize a commodity feature.

14. The device according to claim 13, wherein when the page request comprises a browse request for the commodity data on the page, the second identification logic comprises user information acquiring logic executed by the processor for acquiring, according to the user information carried by the browse request, pre-recorded historical browsing features of the user for the commodity data, and using the historical browsing features as the user preference information.

15. The device according to claim 14, wherein the second identification logic is further configured to pre-record separately different commodity data corresponding to historical operations of the user; identify separately commodity features contained in different commodity data, and use the identified commodity features as historical operation features of the user.

16. The device according to claim 13, wherein when the page request comprises a search request for the commodity data on the page, the second identification logic is further configured to identify a search term corresponding to the search request, wherein the search term indicates the commodity feature; identify, from various stored commodity data, the commodity feature of a same type as the search term, and use the identified commodity feature as the user preference information.

17. The device according to claim 12, wherein the transmitting logic further comprises second transmitting logic for transmitting the one or more tagged sub-images and the commodity main body image to the client, for combination by the client and for display at the client.

18. The device according to claim 12, wherein the transmitting logic further comprises second transmitting logic for transmitting the one or more tagged sub-images and the commodity main body image, for combination and display.

19. A device for displaying information, comprising:
a processor;
a storage medium for tangibly storing thereon program logic for execution by the processor, the program logic comprising:
page request logic executed by the processor for transmitting a page request for commodity data to a server;
acquisition logic executed by the processor for acquiring user preference information;
receiver logic executed by the processor for receiving commodity image data returned from the server, wherein the commodity image data comprises a commodity main body image and at least one tagged sub-image;
filtering-logic executed by the processor for utilizing the user preference information to filter out tagged sub-images which are irrelevant to the user preference information; and
display logic executed by the processor for combining the remaining tagged sub-images, after the filtering process, with the commodity main body image, for rendering and displaying.

20. The device according to claim 19, wherein when the user preference information is stored on the server, the acquisition logic is further configured to:
send a query request to the server, such that the server identifies, according to the query request, the user preference information corresponding to user information; wherein the user information is carried by the query request; and receive the user preference information returned from the server; and
when the user preference information is stored in the client, the acquisition logic is further configured to:
identify, according to the user information, from the user preference information locally stored in the client, the user preference information corresponding to the user information.

21. The device according to claim 19, wherein the filter-out logic is further configured to acquire, from the commodity image data the commodity main body image corresponding to the page request, and filter out, according to the user preference information, from the tagged sub-images corresponding to the commodity main body image, the tagged sub-images which are irrelevant to the user preference information.

22. The device according to claim 19, wherein the page request comprises one or more of a browse request and a search request on the page;
the commodity main body image comprises at least one image, rendered image and dynamic image used to characterize a commodity profile; and
the remaining tagged sub-images comprise one or more of a vector image and a bitmap used to characterize a commodity feature.
